(19) United States
(12) Patent Application Publication
(10) Pub. No.: US 2004/0103525 A1
(43) Pub. Date: Jun. 3, 2004

(54) Apparatus and method of manufacturing coils

(75) Inventor: Cheol Jin Kim, Suwon-City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/406,272

(22) Filed: Apr. 4, 2003

(30) Foreign Application Priority Data
Nov. 29, 2002 (KR) 2002-75156

(51) Int. Cl. H01F 7/06; B23P 19/00

(52) U.S. Cl. 29/605; 29/602.1; 29/745

(57) ABSTRACT

An apparatus and method of manufacturing coils allows an insulating coat to be uniformly formed on a coil to improve an operational reliability of the coil. The apparatus is configured to wind a wire around a winding core, and equipped with an adhesive supply unit to coat an adhesive on the wire to be wound around the winding core, allowing the wound wire to have a coil cohesive power. The method of manufacturing coils includes coating the adhesive on the wire, and winding the wire around the winding core. The adhesive may be coated on the entire wire or a part of the wire.

### CROSS-REFERENCE TO RELATED APPLICATION

This application claims the benefit of Korean Application No. 2002-75156, filed Nov. 29, 2002, in the Korean Intellectual Property Office, the disclosure of which is incorporated herein by reference.

### BACKGROUND OF THE INVENTION

1. Field of the Invention

The present invention relates to an apparatus and method of manufacturing coils, and more particularly, to an apparatus and method of manufacturing coils to form a uniform coat when forming an insulating coat on a coil, improving operational reliability of the coil.

2. Description of the Related Art

Generally, high voltage of over about 2000 V is induced in a coil used in a high voltage transformer (HVT) to drive a magnetron of a microwave oven. For this reason, the coil of the high voltage transformer is electrically insulated using an insulating paper or a resin coat.

FIG. 1 shows a conventional apparatus to form an insulating resin coat on a coil for high voltage transformers, while FIG. 2 shows a coil on which an insulating resin coat is formed. As shown in FIG. 1, when a coil 102 having a plurality of terminals 104 is inserted into a cavity 112 of a mold 106 and a resin is injected into the cavity 112, a resin coat 202 is formed on the coil 102 as shown in FIG. 2. The resin coat 202 is required to form a uniform thickness to completely insulate the coil 102. When the thickness of the resin coat 202 is not uniform, a desired insulating effect is not achieved, thereby causing damage to a machine employing the coil 102.

To solve the problem of maintaining a desired uniform interval between wall surfaces 108 of the cavity 112 and the coil 102 inserted into the cavity 112, a plurality of spacing protrusions 110 are formed on the wall surfaces 108 of the cavity 112, to face an inside of the cavity 112. Because of the spacing protrusions 110, the uniform interval between the wall surfaces 108 of the cavity 112 and the coil 102 inserted into the cavity 112 is desirably maintained, thereby forming the resin coat 202 having a uniform thickness, and producing a desired resin-coated coil 204.

However, when the coil 102 is inserted into the conventional apparatus which forms insulating resin coats on coils for high voltage transformers, and a coat is formed on the coil 102 by injecting a thermoplastic resin, the coil 102 is often entangled or swells up by injection pressure. The coat is thereby not formed in a uniform thickness. If the insulating coat does not have a uniform thickness, it is almost impossible to ensure desired operational reliability of the coil 102.

### SUMMARY OF THE INVENTION

Accordingly, it is an aspect of the present invention to provide an apparatus and method of manufacturing coils to form a uniform coat when forming an insulating coat on a coil, improving operational reliability of the coil.

Additional aspects and advantages of the invention will be set forth in part in the description which follows and, in part, will be obvious from the description, or may be learned by practice of the invention.

The foregoing and/or other aspects of the present invention are achieved by providing an apparatus to manufacture coils including a winding core to be wound around with a wire, and an adhesive supply unit to coat the wire to be wound around the winding core with an adhesive to produce a coil.

The foregoing and/or other aspects of the present invention are also achieved by providing a method of manufacturing coils including coating a wire with an adhesive, and winding the wire coated with the adhesive around a winding core to produce a coil.

The foregoing and/or other aspects of the present invention are also achieved by providing a method of manufacturing coils including coating an entire wire with an adhesive, and winding the wire around a winding core to produce a coil.

The foregoing and/or other aspects of the present invention are also achieved by providing a method of manufacturing coils including coating a part of a wire with an adhesive, and winding the wire around a winding core to produce a coil.

### BRIEF DESCRIPTION OF THE DRAWING

The above and/or other aspects and advantages of the invention will become apparent and more readily appreciated from the following description of the preferred embodiments, taken in conjunction with the accompanying drawings of which:

FIG. 1 is a perspective view of a conventional apparatus to form an insulating resin coat on a coil for high voltage transformers;

FIG. 2 is a perspective view showing a coil on which an insulating resin coat is formed;

FIG. 3 is a perspective view of an apparatus to manufacture coils, according to an embodiment of the present invention; and

FIGS. 4 and 5 are flowcharts illustrating methods of manufacturing coils, according to various embodiments of the present invention.

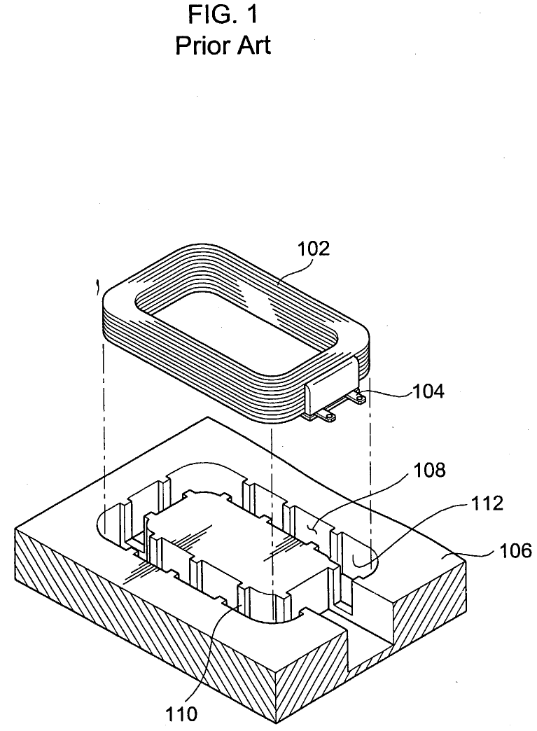

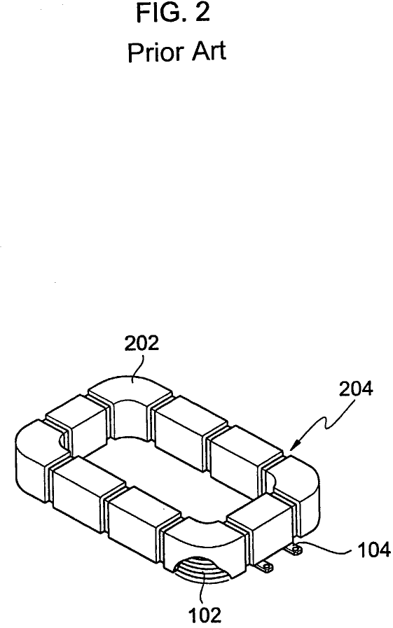

### DETAILED DESCRIPTION OF THE PREFERRED EMBODIMENT

Reference will now be made in detail to the present preferred embodiments of the present invention, examples of which are illustrated in the accompanying drawings, wherein like reference numerals refer to like elements throughout.

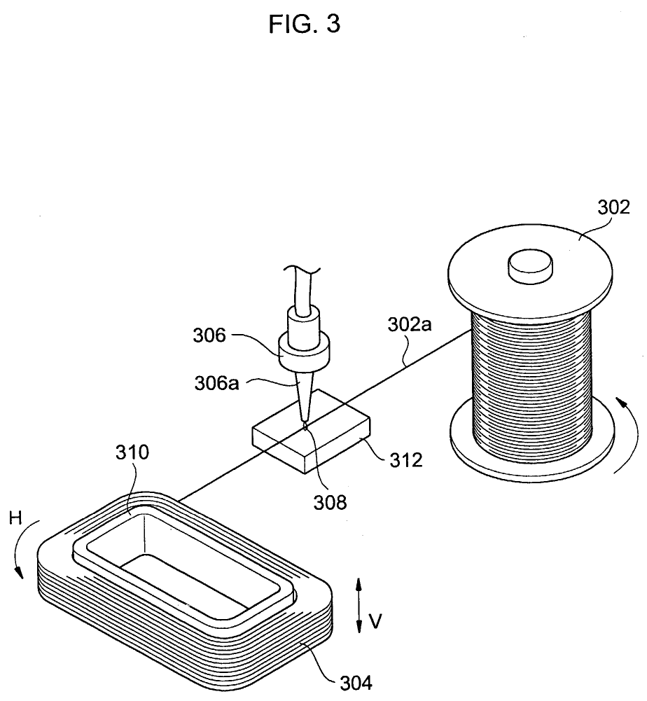

FIG. 3 is a perspective view of an apparatus to manufacture coils, according to an embodiment of the present invention. As shown in FIG. 3, a wire 302a from a coil drum 302 is wound around a winding core 310, producing a coil 304 having a desired shape and a desired number of windings. When the winding core 310 rotates about a vertical axis thereof, as shown by an arrow H in FIG. 3, the coil drum 302 simultaneously rotates by rotation of the winding core 310 in the same direction. The wire 302a is wound around the winding core 310. In such a case, the winding core 310 reciprocates in a vertical direction (V) within a predetermined range, thus the wire 302a wound around the winding core 310 forms layers. Before the wire 302a unwound from the coil drum 302 is wound around the winding core 310, an adhesive 308 supplied from an adhesive supply unit 306 is coated on the wire 302a. A contact pad 312, which has a soft texture and is capable of absorbing the adhesive, is installed under the adhesive supply unit 306. The wire 302a unwound from the coil drum 302 is coated with the adhesive 308 while passing over the contact pad 312 such that the wire 302a is in contact with the contact pad 312. The wire 302a coated with the adhesive 308 is then wound around the winding core 310, thus producing the coil 304. The coil 304 is cohesive by the coated adhesive 308 and thus, is not entangled or loosened. Preferred examples of adhesives which are useful in the present invention include adhesives having insulating capacity, such as varnish.

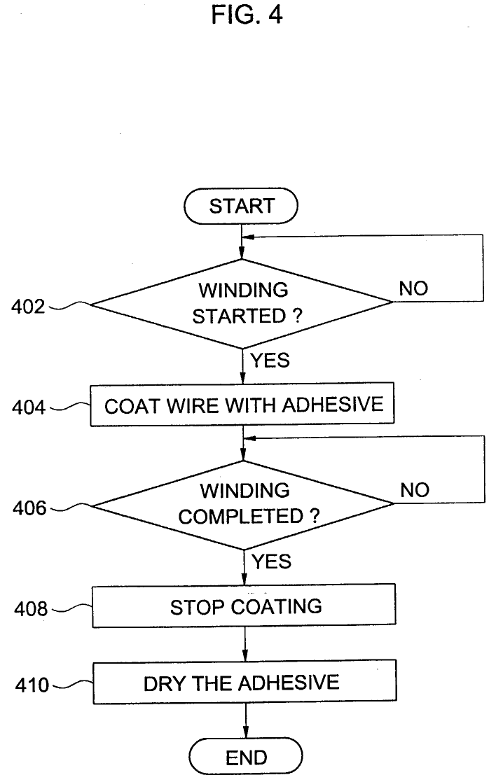

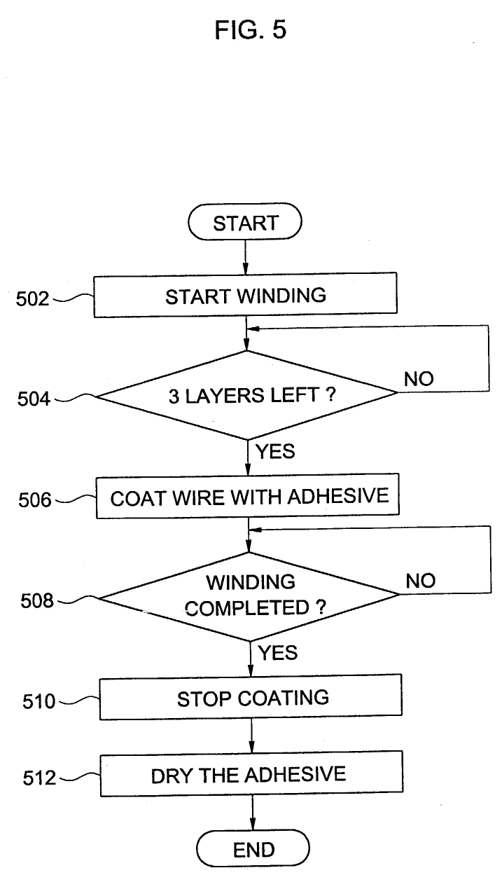

FIGS. 4 and 5 are flowcharts showing methods of manufacturing coils according to various embodiments of the present invention. As described in FIG. 4, an adhesive is coated on an entire wire. In operation 402, it is primarily determined whether winding of the wire is started. When it is determined that the winding of the wire is started, an adhesive is coated on the wire to be wound around a winding core in operation 404. Thereafter, it is determined in operation 406 whether the winding is completed. When the winding is completed, the coating with the adhesive is stopped in operation 408. After the the coating is stopped, an adhesive-drying work is started in operation 410.

As described in FIG. 5, only a predetermined length of a wire corresponding to the last three layers of total windings is coated with an adhesive. In operation 502, the wire starts to be wound around a winding core in operation 502. Then, it is determined in operation 504 whether only the predetermined length of the wire corresponding to the last three layers of total windings is left in an unwound state. When only the length of the wire corresponding to the last three layers of total windings is left in the unwound state, a remaining part of the wire to be wound around the winding core is coated with the adhesive in operation 506. Thereafter, it is determined in operation 508 whether the winding of total windings is completed. When the winding of total windings is completed, the coating with the adhesive is stopped in operation 510. Then, an adhesive-drying work is started in operation 512.

To dry the adhesive coated on the wire, the following methods may be employed. That is, after the winding is completed, a resulting coil may be dried in a drying furnace, or by using warm air supplied by a fan heater. Alternatively, the resulting coil may be dried by directly applying DC power to the coil and thus, generating heat in the coil itself.

As described above, when a coil is wound around a winding core, the apparatus and method of manufacturing coils according to the present invention coats a wire with an adhesive to make the resulting wire cohesive, thus preventing the wire wound around the winding core from being entangled or loosened, and forming a uniform coat to improve an operational reliability of the coils.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An apparatus to manufacture coils, comprising:
a winding core to be wound around with a wire; and
an adhesive supply unit to coat the wire to be wound around the winding core with an adhesive to produce a coil.

2. The apparatus as set forth in claim 1, wherein the adhesive is an insulating material.

3. The apparatus as set forth in claim 1, wherein the adhesive is varnish.

4. A method of manufacturing coils, comprising:
coating a wire with an adhesive; and
winding the wire coated with the adhesive around a winding core to produce a coil.

5. The method as set forth in claim 4, wherein the adhesive is an insulating material.

6. The method as set forth in claim 4, wherein the adhesive is varnish.

7. The method as set forth in claim 4, wherein the coil is dried when the coating of the wire with the adhesive is completed.

8. The method as set forth in claim 7, wherein the coil is dried in a drying furnace.

9. The method as set forth in claim 7, wherein the coil is dried using warm air supplied by a fan heater.

10. The method as set forth in claim 7, wherein the coil is dried by directly applying DC power to the coil, generating heat in the coil to allow the coil to dry.

11. A method of manufacturing coils, comprising:
coating an entire wire with an adhesive; and
winding the wire coated with the adhesive around a winding core to produce a coil.

12. The method as set forth in claim 11, wherein the adhesive is an insulating material.

13. The method as set forth in claim 11, wherein the adhesive is varnish.

14. The method as set forth in claim 11, wherein the coil is dried when the winding of the wire is completed.

15. A method of manufacturing coils, comprising:
coating a part of a wire with an adhesive; and
winding the wire around a winding core to produce a coil.

16. The method as set forth in claim 15, wherein the adhesive is an insulating material.

17. The method as set forth in claim 15, wherein the adhesive is varnish.

18. The method as set forth in claim 15, wherein the part of the wire to be wound and coated with the adhesive is a predetermined length of a tail part of the wire.

19. The method as set forth in claim 15, wherein the coil is dried when the winding of the wire is completed.

20. An apparatus to manufacture coils, comprising:
a coil drum;
a winding core;
a wire unwound from the coil drum to be wound around the winding core;
an adhesive supply unit to coat the wire to be wound around the winding core with an adhesive; and
a contact pad installed under the adhesive supply unit to absorb the adhesive, while the wire passes under the adhesive supply unit and contacts the contact pad,
wherein, the wound wire coated with the adhesive is wound around the winding core to produce a cohesive coil.

21. The apparatus as set forth in claim 20, wherein the winding core and the coil drum rotate simultaneously about a vertical axis.

22. The apparatus as set forth in claim 20, wherein the winding core is configured to move in a vertical direction within a predetermined range so that the wire wound thereabout forms layers.
